(19) United States
(12) Patent Application Publication
(10) Pub. No.: US 2012/0275148 A1
(43) Pub. Date: Nov. 1, 2012

(54) OPTICAL REFLECTIVE FILM AND LIGHT EMITTING DEVICE USING THE SAME

(76) Inventors: Wei-Ting YEH, Taoyuan County (TW); Chia-Yin Yao, Taoyuan County (TW); Chia-Chang Chang, Taoyuan County (TW); Wen-Sheng Wang, Taoyuan County (TW)

(21) Appl. No.: 13/188,467

(22) Filed: Jul. 22, 2011

(30) Foreign Application Priority Data
Apr. 29, 2011 (TW) 100115026

(51) Int. Cl. F21V 7/00; G02B 5/22; G02B 1/11

(52) U.S. Cl. 362/235; 359/586; 359/361

(57) ABSTRACT

An optical reflective film and a light emitting device are provided. The optical reflective film includes a main body, organic particles, inorganic particles, and voids. The main body is made of polyolefin. A refractive index difference N of the optical reflective film is defined in the following equation, and its value ranges from 0.05 to 0.7:

$$N = \frac{\vert ( blr - alr ) \times blc \vert + \vert ( clr - alr ) \times clc \vert + \vert ( dlr - alr ) \times dlc \vert}{100}$$

In above equation, alr is refractive index of polyolefin, alc is weight percentage of the main body in the optical reflective film. blr is refractive index of the organic particles disposed in the main body, blc is weight percentage of the organic particles, clr is refractive index of inorganic particles disposed in the main body; clc is weight percentage of organic particles; dlr is refractive index of voids disposed in the main body, and dlc is the void ratio of optical reflective film.

### FIELD OF INVENTION

The invention relates an optical element and a light emitting device using the same, and especially relates to an optical reflective film and a light emitting device using the same.

### BACKGROUND OF THE INVENTION

The liquid crystal display has replaced the CRT display as the main stream display device in the display industry. The liquid crystal display includes a liquid crystal panel and a backlight module. The backlight module includes a case having a containing space, a light emitting or illumination source, and an optical reflective film. The light source and the optical reflective film are disposed in the containing space. Some parts of the light emitting from the light emitting source is reflected by the optical reflective film and propagated into the light-output surface of the backlight module.

Nowadays, the optical reflective films found in the current market are mainly made of white polyester film. The white polyester film is substantially comprised of polyethylene terephthalate. In the backlight module, the optical reflective films have the characteristics of higher whiteness and higher light reflectance, so that the adding of high concentration of white dye or inorganic particles into the white polyester film is needed. The refraction of light caused by the refractive index difference between the white polyester film and the inorganic particles leads to the rise of the light reflectance of the optical reflective film.

However, the main raw material of the optical reflective film is polyethylene terephthalate. During the production of the optical reflective film, the drying of material for an extended period of time is needed so as to decrease the water content thereof. However, the drying of material brings the problems of higher operating temperature and harsher production conditions, and thus the production cost of the optical reflective film is raised. Furthermore, the addition of higher concentration of additives, for example: a white dye, is needed, and thus causing higher costs to the raw material.

Therefore, a person skilled in the art offers other kinds of optical reflective film, and the primary material of the optical reflective film is not polyethylene terephthalate. For instance, an optical reflective film is provided in U.S. Pat. No. 5,710,856. The optical reflective film includes a porous resin sheet and a protective layer. The protective layer is laminated on the porous resin sheet. The porous resin sheet is substantially comprised of the polyolefin resin. Furthermore, a plurality of inorganic particles is disposed in the porous resin sheet. The light reflectance of the optical reflective film is 95% or more. However, in the optical reflective film, the weight percentage of the inorganic particles in the optical reflective film is higher, ranging from 50% to 75%. Because the material of the inorganic particles is expensive, the material cost of the optical reflective film becomes higher.

### SUMMARY OF THE INVENTION

One aspect of the invention is to provide an optical reflective film, and optical reflective film having lowered production and material costs.

Another aspect of the invention is to provide a light emitting device. The optical reflective film is used in the light emitting device, so the production and material costs of the light emitting device are lower.

To achieve the foregoing and other aspects, an optical reflective film is provided. The optical reflective film includes a main body, a plurality of organic particles, a plurality of inorganic particles, and a plurality of voids. The main body is substantially comprised of polyolefin resin. A refractive index difference N of the optical reflective film is defined as the following equation and the value of N ranges from 0.05 to 0.7.

$$N = \frac{\vert ( blr - alr ) \times blc \vert + \vert ( clr - alr ) \times clc \vert + \vert ( dlr - alr ) \times dlc \vert}{100} \qquad [ 1 ]$$

In the above equation [1], alr is the refractive index of polyolefin, alc is the weight percentage of the main body in the optical reflective film. blr is the refractive index of organic particles disposed in the main body, blc is the weight percentage of the organic particles, clr is the refractive index of the inorganic particles disposed in the main body; clc is the weight percentage of the organic particles; dlr is the refractive index of the voids disposed in the main body, and dlc is the void ratio of the optical reflective film.

In the optical reflective film, the weight percentage of the organic particles in the optical reflective film is between 1% and 15%.

In the optical reflective film, the diameter of the organic particle is ranged from 0.1 μm to 10 μm.

In the optical reflective film, the refractive index of the organic particle (blr) is ranged from 1.30 to 1.70.

In the optical reflective film, the weight percentage of the inorganic particles (clc) is between 1% and 24%.

In the optical reflective film, the diameter of the inorganic particle is ranged from 0.01 μm to 1 μm.

In the optical reflective film, the refractive index of the inorganic particle (clr) is ranged from 1.59 to 2.6.

In the optical reflective film, a plurality of fluorescent brightening agents is disposed in the main body. The weight percentage of the fluorescent brightening agents in the optical reflective film is between 0.001% and 0.5%.

In the optical reflective film, a plurality of ultraviolet light absorbers is disposed in the main body. The weight percentage of the ultraviolet light absorber in the optical reflective film is between 0.02% and 1%.

In the optical reflective film, the degree of crystallinity of the polyolefin resin in the main body is between 30% and 70%.

In the optical reflective film, at least one protective layer is disposed on the surface of the main body.

To achieve the foregoing and other aspects, a light emitting device is provided. The light emitting device includes a case, a light emitting source, and the above-described reflective film. The case has a containing space, and the light emitting source is disposed in the containing space. The light emitting source emits a plurality of beams of light and generates a plurality of optical paths. The optical reflective film is disposed in the containing space and used for reflecting some portions of the light.

In the optical reflective film, the addition of the organic particles in the main body can increase the formation of voids. The voids and the inorganic particles can work in corporation to raise the whiteness and light reflectance of the optical reflective film. The main body of the optical reflective film is substantially comprised of polyolefin resin, and the polyolefin resin has the non-absorbent characteristic, thus the process of drying of materials is not needed in the manufacturing process of the optical reflective film. Because the formation temperature of the polyolefin resin is lower, the required temperature in the extension formation process of the optical reflective film is lower. Furthermore, unlike the optical reflective film disclosed in the U.S. Pat. No. 5,710,856, to achieve higher light reflectance, lower concentration of the inorganic particle only is to be added in the optical reflective film of the present invention. To sum up, the production cost of the optical reflective film in the present invention is lower as compared with the above conventional technology.

The above and other aspects, features, and advantages of the present invention will become more apparent from the following detailed description when taken in conjunction with the accompanying drawings.

### BRIEF DESCRIPTION OF THE DRAWINGS

FIG. 1 shows an inner structure of an optical reflective film according to an embodiment in the present invention.

FIG. 2 shows the comparison of the light reflectance between the optical reflective film with fluorescent brightening agents and the optical reflective film without fluorescent brightening agents.

FIG. 3 shows the relationship between the weight percentage of the fluorescent brightening agents and the whiteness, light reflectance

FIG. 4 shows the additive amount of the ultraviolet light absorbers and the variation of yellowing index of the optical reflective film.

FIG. 5 shows the relationship between the degree of crystallinity of the polyolefin resin and the shrinkage rate of the optical reflective film.

FIG. 6 shows the relationship between the light reflectance of the optical reflective film and the weight percentage of the inorganic particles.

FIG. 7 shows a first embodiment of a light emitting device using the optical reflective film of the embodiment in the present invention.

FIG. 8 shows a second embodiment of the light emitting device using the optical reflective film of the embodiment in the present invention.

FIG. 9 shows a third embodiment of the light emitting device in the present invention.

### DETAILED DESCRIPTION OF THE INVENTION

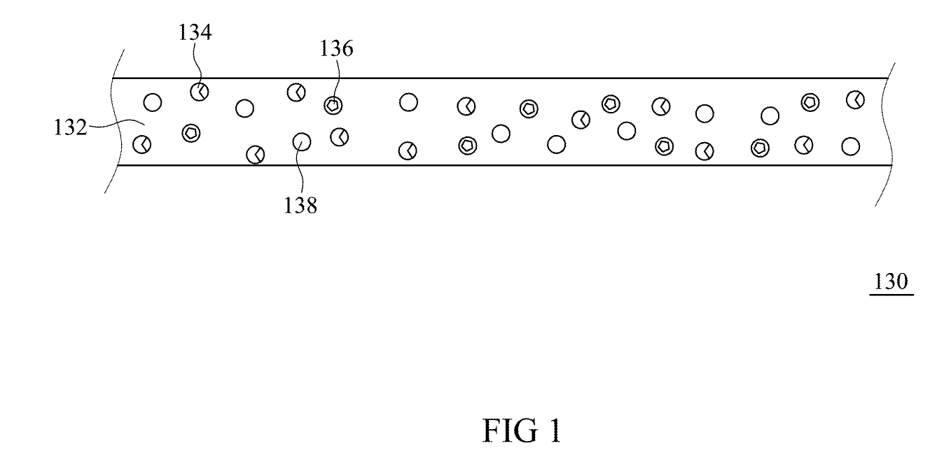

Please refer to FIG. 1 in which an inner structure of an optical reflective film 130 for an embodiment of present invention is shown. The optical reflective film 130 includes a main body 132, a plurality of organic particles 134, a plurality of inorganic particles 136, and a plurality of voids 138. The main body 132 is substantially comprised of polyolefin resin, for example: polypropylene. A refractive index difference N of the optical reflective film 130 is defined in the following equation in this embodiment:

$$N = \frac{\vert ( blr - alr ) \times blc \vert + \vert ( clr - alr ) \times clc \vert + \vert ( dlr - alr ) \times dlc \vert}{100} \qquad [ 1 ]$$

In the above equation [1], the refractive index of the polyolefin resin is alr, and the weight percentage of the polyolefin resin in the optical reflective film 130 is alc. The organic particles 134 are disposed in the main body 132. The refractive index of the organic particles 134 is blr, and the weight percentage of the organic particles 134 in the optical reflective film 130 is blc. The voids 138 are disposed in the main body 132. The refractive index of the voids 138 is dlr, and the void ratio of the optical reflective film 130 is dlc.

Furthermore, The value of N is ranged from 0.05 to 0.7. In this embodiment, the weight percentage of the polyolefin resin in the optical reflective film is between 1% and 15%.

In this embodiment, the material of the organic particle 134 is polymethylmethacrylate or polycarbonate. In the manufacturing process of the optical reflective film 130, the adding of the organic particles 134 offers the seeding for the formation of the voids 138. Furthermore, the addition of organic particles 134 is helpful for the formation of laminated structure in the main body 132, and the laminated structure is helpful in enhancing the mechanical strength and the dimensional stability of the optical reflective film. Due to the refractive index difference between the organic particles 134 and the main body 132, the entire light reflectance of the optical reflective film 130 is increased. In this embodiment, the refractive index of the organic particles 134 is between 1.3 and 1.7.

The weight percentage of the organic particles 134 (blc) in the optical reflective film 130 is between 1% and 15%, preferably between 7% and 15%, and more preferably between 10% and 15%. According to the experimental result, if the weight percentage of the organic particles 134 (blc) is lower than 1%, the light reflectance of the optical reflective film 130 will be decreased; if the weight percentage (blc) is above 15%, the light reflectance of the optical reflective film 130 will not be increased significantly; if the weight percentage of the organic particles 134 (blc) is above 15%, the breakdown of the optical reflective film 130 can easily occur.

In this embodiment, the diameter of the organic particle 134 is ranged from 0.1 μm to 10 μm, for example: 4 μm, preferably 2 and more preferably 1 μm. The fact that the diameter of the organic particle 134 is larger than 10 μm probably causes the laminated structure to not being formed after the extension of the optical reflective film 130, thereby making the voids 138 too large, and leading to decreased light reflectance of the optical reflective film 130. If the diameter of the organic particle 134 is smaller than 0.1 μm, the organic particles 134 will not be distributed uniformly.

In this embodiment, the material of the inorganic particle 136 is titanium dioxide (TiO₂) or barium sulfate (BaSO₄). However, the material of the inorganic particle 136 is not limited to TiO₂ or BaSO₄. The refractive index of the inorganic particle 136 is ranged from 1.59 to 2.6. The refractive index of the inorganic particle 136 can be 1.59, and preferably 2.0. If the refractive index of the inorganic particle 136 is different from the refractive index of the main body 132 of the optical reflective film 130. Due to the refractive index difference between the inorganic particles 136 and the main body 132, the entire light reflectance of the optical reflective film 130 is increased.

The diameter of the inorganic particle 136 is ranged from 0.01 μm to 1 μm, for example: preferably at 0.5 μm, and more preferably at 0.2 μm. The diameter of the inorganic particle 136 is smaller than the diameter of the organic particle 134, so that the coverage ratio of the inorganic particles 136 is higher than the organic particles 134 in the optical reflective film 130. If the diameter of the inorganic particle 136 is larger than 1 μm, the coverage ratio of the inorganic particles 136 will be decreased. However, the fact that the diameter of the inorganic particle 136 is smaller than 0.01 μm makes the inorganic particles 136 aggregate easily, and causes poor distribution of the inorganic particles 136.

The weight percentage of the inorganic particles 136 (clc) in the optical reflective film 130 is between 1% and 24%. According to the experiment result, when the weight percentage of the inorganic particles 136 (clc) is less than 1%, and the corresponding coverage ratio is decreased so as to reduce the light reflectance. When the weight percentage of the inorganic particles 136 (clc) is larger than 24%, the light reflectance of the optical reflective film 130 is not able to be raised significantly.

Furthermore, in order to increase the whiteness of the optical reflective film 130, a plurality of fluorescent brightening agents (not shown) is disposed in the optical reflective film 130. The fluorescent brightening agents absorb the lower wavelength light in the wavelength band of 300 nm to 400 nm and illuminate the higher wavelength light in the wavelength band of 420 nm to 480 nm, so as to increase the whiteness of the optical reflective film 130.

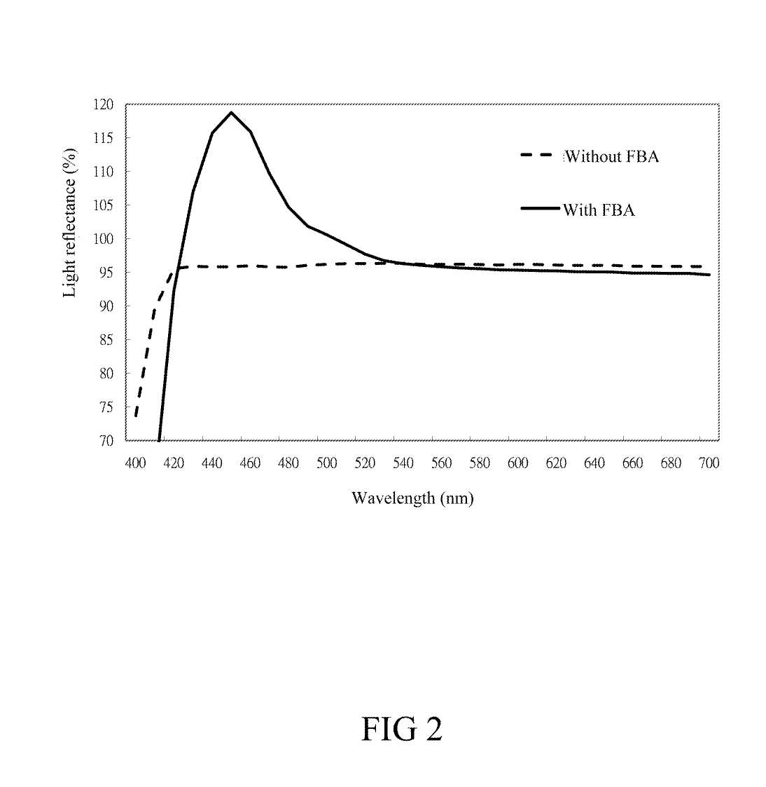

Please refer to FIG. 2. FIG. 2 shows the comparison of the light reflectance between the optical reflective film with the fluorescent brightening agents (FBA) and the optical reflective film without the fluorescent brightening agents. As shown in FIG. 2, in the wavelength band of 420 nm˜540 nm, the light reflectance of the optical reflective film with the fluorescent brightening agents is lower than the light reflectance of the optical reflective film without the fluorescent brightening agents.

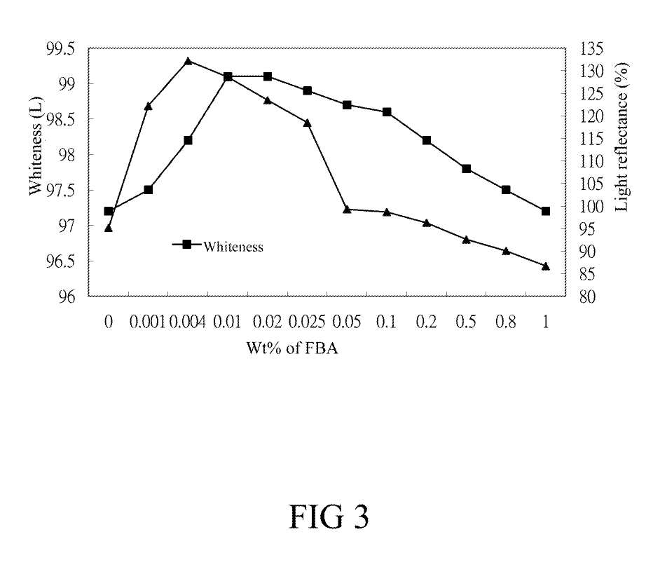

Please refer to FIG. 3. FIG. 3 shows the relationships between the weight percentage of the fluorescent brightening agents (wt % of FBA) with respect to the whiteness, and the light reflectance, respectively. As shown in FIG. 3, the whiteness of the optical reflective film 130 cannot be increased effectively when the weight percentage of the fluorescent brightening agents is less than 0.001%. However, if the weight percentage of the fluorescent brightening agents is larger than 0.5%, the light reflectance of the optical reflective film is lower than 95%. In this embodiment, the fluorescent brightening agent is made of 1,1′-Biphenyl-4,4′-bis[2-(methoxyphenyl)ethenyl], 2,2′-(2,5-Thiophenediyl)bis[5-tert-butylbenzoxazole], or 2,2′-(1,2-Ethenediyldi-4,1-phenylene)bisbenzoxazole. Therefore, the weight percentage of the fluorescent brightening agents is preferably between 0.001% and 0.5%.

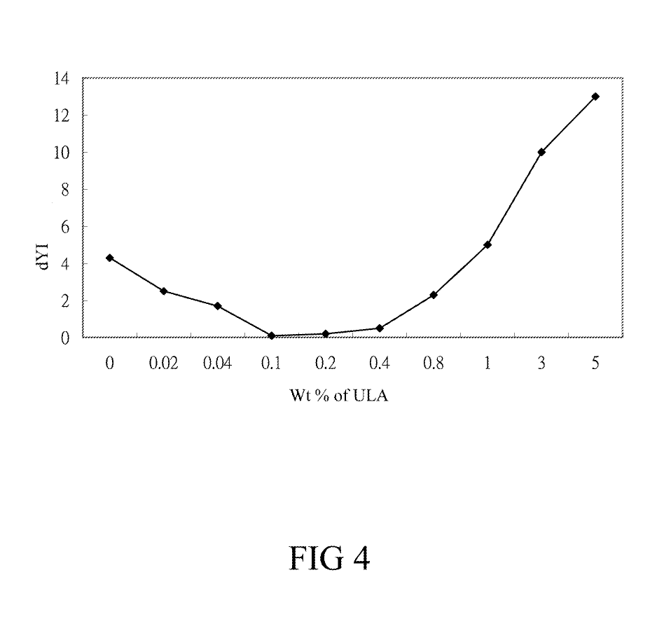

Furthermore, a plurality of ultraviolet light absorbers is preferably added in the optical reflective film 130. The ultraviolet light absorbers is used for absorbing the ultraviolet light emitted from the light illuminating source 120, so as to prevent the optical reflective film 130 from becoming yellowing. The ultraviolet light absorbers absorb the ultraviolet light and transform the light energy into heat. Please refer to FIG. 4. FIG. 4 shows the relationship between the additive amount of the ultraviolet light absorbers (wt % of ULA) and the variation of yellowing index of the optical reflective film. In FIG. 4, the horizontal axis represents the weight percentage of the ultraviolet light absorbers in the optical reflective film 130, and the vertical axis represents the variation of the yellowing index (dYI). In this embodiment, the variation of the yellowing index is defined as the variation of the yellowing index of the optical reflective film 130 after being illuminated by the ultraviolet light in the wavelength of 280 nm˜400 nm for 96 hours. As shown in FIG. 4, adding too much ultraviolet light absorbers will affect conversion efficiency negatively, and thereby aggravating the yellowing problem, whereas, on the other hand, adding too little ultraviolet light absorber to the optical reflective film 130 will bring about limited effectiveness thereof. According to the experiment result, the optical reflective film 130 possesses better anti-yellowing property if the weight percentage of the ultraviolet light absorbers is between 0.02% and 1%, and preferably between 0.1% and 0.4%.

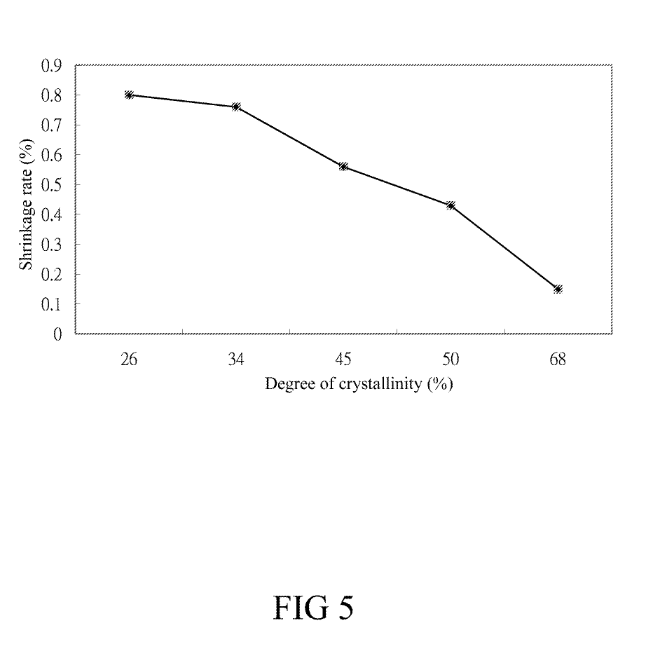

The main body 132 of the optical reflective film 130 is substantially comprised of polyolefin resin. The polyolefin resin is of a crystalline plastic. The rigidity, the heat resistance, and the dimensional stability of the polyolefin resin will become better when the degree of crystallinity of the polyolefin resin is higher. Please refer to FIG. 5. FIG. 5 shows the relationship between the degree of crystallinity of the polyolefin resin and the shrinkage rate of the optical reflective film. As shown in FIG. 5, the shrinkage rate is lower as the degree of crystallinity is higher. In this embodiment, the shrinkage rate of the optical reflective film 130 is lower than 0.5% when the degree of crystallinity of the polyolefin resin of the optical reflective film is between 30% and 70%, and preferably between 48% and 70%.

To sum up, the main body 132 of the optical reflective film 130 is substantially comprised of polyolefin resin, and the polyolefin resin has the non-absorbent characteristic, so that the process of drying of materials is not needed in the manufacturing of the optical reflective film 130. Because the formation temperature of the polyolefin resin is lower, the required temperature in the extension formation process of the optical reflective film 130 is also lower, and thus the production cost is thereby lower. In this embodiment, the organic particles 134 are disposed in the optical reflective film 130, and the refractive index of the organic particles 134 is different from the refractive index of the main body 132 of the optical reflective film 130, so that the light reflectance of the optical reflective film 130 can be increased. Furthermore, the addition of the organic particles 134 can increase the formation of the voids 138. The voids 138 can further raise the light reflectance of the optical reflective film 130. To sum up, the production cost of the optical reflective film of the present embodiment in the present invention is lower.

Please refer to Table 1. Table 1 shows the relationship between the weight percentage of the organic particles and the void ratio, the refractive index difference, the whiteness, and the light reflectance. In the sets of 11 experiments shown in Table 1, no inorganic particle is added in the optical reflective film. In these experiments, the material of inorganic particles is polymethyl methacrylate. As shown in Table 1, the void ratio of the optical reflective film is increased significantly when the weight percentage of the organic particles is above 5%. However, the void ratio of the optical reflective film is not increased significantly when the weight percentage of the organic particles is above 15%. The optical reflective film is then breakdown/ruptured/fractured when the weight percentage of the organic particles is above 50%. When the weight percentage of organic particles is above 7%, the refractive index difference of the optical reflective film correspondingly will be increased, so as to increase the light reflectance and the whiteness of the optical reflective film.

TABLE 1

| | Weight percentage of | | | | | | |
|---|---|---|---|---|---|---|---|
| | prescriptions | | | Refractive | | | |
| | % of | % of | void | index | | Light | |
| | organic | inorganic | ratio | difference | Whiteness | reflectance (%) | |
| Experiment | particles | particles | (%) | (N) | (L) | at 450 nm | at 550 nm |
| Experiment 1 | 1 | 0 | 0 | 0.00 | 85.3 | 78.1 | 78.5 |
| Experiment 2 | 3 | 0 | 0 | 0.00 | 93.7 | 87.3 | 84.2 |
| Experiment 3 | 5 | 0 | 20 | 0.10 | 96.5 | 93.1 | 93.4 |
| Experiment 4 | 7 | 0 | 38 | 0.19 | 98 | 95.2 | 96.5 |
| Experiment 5 | 10 | 0 | 40 | 0.20 | 98.5 | 96.1 | 96.8 |
| Experiment 6 | 15 | 0 | 45 | 0.22 | 98.6 | 96.5 | 96.8 |
| Experiment 7 | 20 | 0 | 45 | 0.22 | 98.5 | 96.3 | 96.4 |
| Experiment 8 | 25 | 0 | 46 | 0.23 | 98.9 | 96.4 | 96.8 |
| Experiment 9 | 30 | 0 | 44 | 0.22 | 98.9 | 96.5 | 96.5 |
| Experiment | 40 | 0 | 44 | 0.22 | 98.9 | 96.5 | 96.9 |
| 10 | | | | | | | |

| | | | |
|---|---|---|---|
| Experiment | 50 | 0 | optical reflective film breakdown |
| 11 | | | |

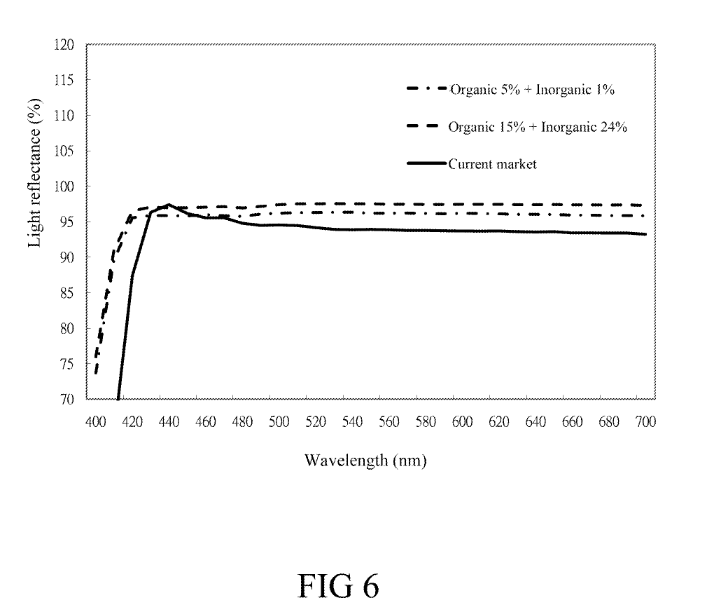

Please refer to FIG. 6. FIG. 6 shows the relationship between the light reflectance of the optical reflective film and the weight percentage of the inorganic particles. In FIG. 6, the light reflectance at various wavelengths of the optical reflective film in the current market and that of the optical reflective films of two different embodiments of present invention are shown. As shown in FIG. 6, when the weight percentage of the organic particles is 15% and the weight percentage of the inorganic particles is 24%, the light reflectance of the optical reflective film will reach the peak value. Furthermore, as shown in FIG. 6, the light reflectance of the optical reflective film in the current market is less than the light reflectance of the optical reflective films of the embodiments in the present invention in most of the wave length bands.

Please refer to Table 2. Table 2 shows the relationship between the weight percentages of the organic particles, the inorganic particles and the void ratio, and the refractive index difference, the whiteness, and the light reflectance. In the experiments shown in Table 2, the material of the organic particles is polymethyl methacrylate, and the material of the inorganic particles is titanium dioxide. As shown in Table 2, the optical reflective film possesses good optical properties even if the weight percentages of the organic particles and inorganic particles are not high. For example, the whiteness of the optical reflective film is 98.2 and the light reflectance thereof is 95%, when the weight percentage of the organic particles is 5% and the weight percentage of the inorganic particles is 1%. Because the weight percentage of the inorganic particles is lower, the cost of the optical reflective film can be reduced.

Please, continue to refer to Table 2. The optical reflective film which possesses the best optical properties is for example: the whiteness is 99.1 and the light reflectance is 97%, when the weight percentage of the organic particles is 15% and the weight percentage of the inorganic particles is 24%. However, the optical reflective film will be breakdown if the weight percentage of the inorganic particles is 36% and the weight percentage of organic particles is above 10%. As shown in Table 1 and Table 2, adding too much in the amounts of organic particles and inorganic particles is not helpful in improving the optical properties of the optical reflective film, but would decrease the production yield of the optical reflective film.

TABLE 2

| | Weight percentage of | | | | | | |
|---|---|---|---|---|---|---|---|
| | prescriptions | | | Refractive | | | |
| | % of | % of | void | index | | Light | |
| | organic | inorganic | ratio | difference | Whiteness | reflectance | |
| Experiment | particles | particles | (%) | (N) | (L) | at 450 nm | at 550 nm |
| Experiment | 1 | 1 | 0 | 0.13 | 97.1 | 90.1 | 92.1 |
| 12 | | | | | | | |
| Experiment | 3 | 1 | 0 | 0.13 | 97.8 | 90.8 | 93.5 |
| 13 | | | | | | | |
| Experiment | 5 | 1 | 20 | 0.24 | 98.2 | 95.8 | 96.5 |
| 14 | | | | | | | |
| Experiment | 10 | 1 | 40 | 0.32 | 98.7 | 96.2 | 97.2 |
| 15 | | | | | | | |
| Experiment | 15 | 1 | 42 | 0.34 | 98.9 | 96.5 | 97.1 |
| 16 | | | | | | | |
| Experiment | 25 | 1 | 45 | 0.36 | 98.9 | 96.7 | 97.2 |
| 17 | | | | | | | |
| Experiment | 1 | 12 | 0 | 0.13 | 97.2 | 90.2 | 91.3 |
| 18 | | | | | | | |
| Experiment | 3 | 12 | 0 | 0.13 | 97.5 | 91.2 | 93.2 |
| 19 | | | | | | | |
| Experiment | 5 | 12 | 21 | 0.24 | 98.5 | 96.5 | 96.8 |
| 20 | | | | | | | |
| Experiment | 10 | 12 | 39 | 0.32 | 98.9 | 96.7 | 97 |
| 21 | | | | | | | |
| Experiment | 15 | 12 | 43 | 0.34 | 99 | 96.7 | 97.3 |
| 22 | | | | | | | |
| Experiment | 25 | 12 | 46 | 0.36 | 99 | 96.9 | 97.3 |
| 23 | | | | | | | |
| Experiment | 1 | 24 | 20 | 0.36 | 99.1 | 97 | 97.2 |
| 24 | | | | | | | |
| Experiment | 3 | 24 | 26 | 0.39 | 99.1 | 97 | 97.5 |
| 25 | | | | | | | |
| Experiment | 5 | 24 | 30 | 0.41 | 99.1 | 97.1 | 97.6 |
| 26 | | | | | | | |
| Experiment | 10 | 24 | 40 | 0.46 | 99 | 97.1 | 97.6 |
| 27 | | | | | | | |
| Experiment | 15 | 24 | 46 | 0.49 | 99.1 | 97.2 | 97.9 |
| 28 | | | | | | | |
| Experiment | 25 | 24 | 47 | 0.50 | 99 | 97.1 | 97.9 |
| 29 | | | | | | | |
| Experiment | 1 | 36 | 20 | 0.50 | 99 | 97.1 | 97.8 |
| 30 | | | | | | | |
| Experiment | 3 | 36 | 27 | 0.53 | 99 | 97.1 | 97.9 |
| 31 | | | | | | | |
| Experiment | 5 | 36 | 31 | 0.55 | 99.1 | 97.2 | 97.9 |
| 32 | | | | | | | |

| | | | |
|---|---|---|---|
| Experiment | 10 | 36 | optical reflective film breakdown |
| 33 | | | |
| Experiment | 15 | 36 | optical reflective film breakdown |
| 34 | | | |
| Experiment | 25 | 36 | optical reflective film breakdown |
| 35 | | | |

In the above embodiments, the light reflectance, the whiteness, and the yellowing index are measured by the spectrophotometer, category number: CM-3600D, of Konica Minolta. The degree of crystallinity is calculated by the following equation: degree of crystallinity=(ΔHi/ΔHβ)×100%. ΔHi represents the heat released from the plastic material at the melting point. ΔHβ represents the heat released from the plastic material when the degree of crystallinity is 100%. The degree of crystallinity of polyolefin resin in the optical reflective film is analyzed and calculated by using a differential scanning calorimetry. The void ratio is calculated by using the following equation: void ratio=[1−(d2/d1)]×100%. The d1 represents the density of parent material (having no void) of the optical reflective film 130. The d2 represents the density of the optical reflective film 130. Therefore, the void ratio of the optical reflective film can be obtained by measuring the density of the parent material and the density of the optical reflective film 130.

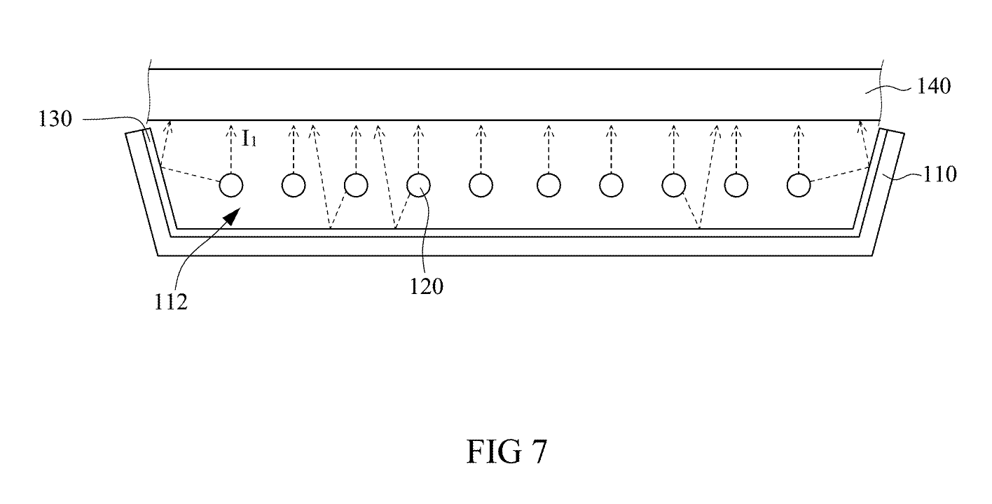

Please refer to FIG. 7. FIG. 7 shows a first embodiment of a light emitting device using the optical reflective film in the present invention. The light emitting device is a direct type backlight assembly. The backlight assembly 100 includes a case 110, a light emitting source 120, an optical reflective film 130, and a diffusion plate 140. The case 110 has a containing space 112 in which the light emitting source 120 is disposed. The light emitting source 120 is comprised of a plurality of cold cathode fluorescent lamps or a plurality of LED light bars. The optical reflective film 130 is disposed in the bottom of the containing space 112 and covers the bottom surface of the case 110. A plurality of light beams I₁ is emitted from the light emitting source 120. Some portions of light beams I₁ are reflected by the optical reflective film 130 and transmitted into the diffusion plate 140. The paths that the light beams I₁ which are passing are defined as optical paths. Because the optical reflective film 130 has higher light reflectance, the brightness of the backlight assembly 100 of the embodiment is higher than the conventional backlight assembly.

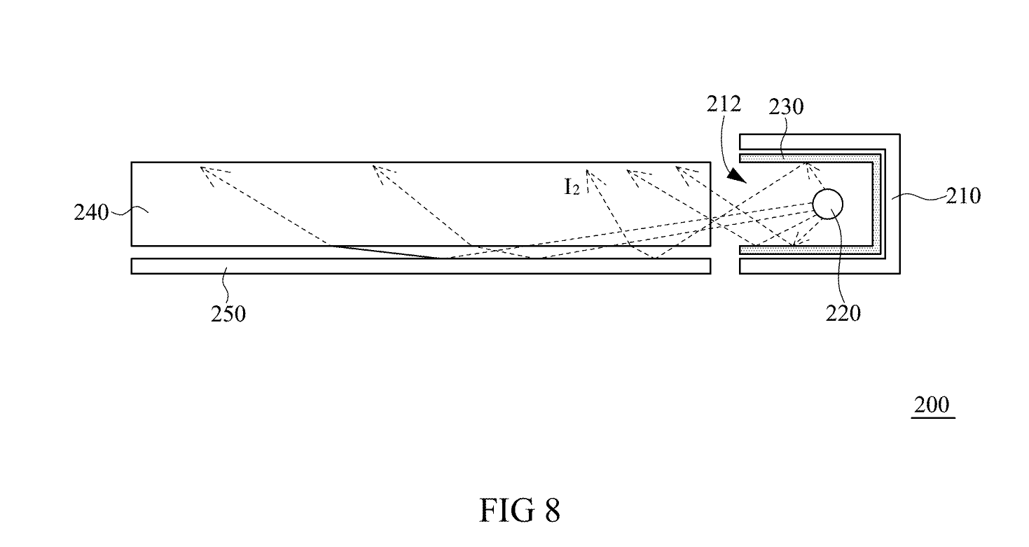

The light emitting device shown in FIG. 7 is the direct type backlight assembly. However, the optical reflective film in the present invention can also be used in the edge type backlight assembly or other types of light emitting device. Please refer to FIG. 8. FIG. 8 shows a second embodiment of the light emitting device using the optical reflective film in the present invention. The backlight assembly 200 includes a case 210, a light emitting source 220, an optical reflective film 230, a light guide plate 240, and a reflective sheet 250. The case 210 has a containing space 212 in which the light emitting source 220 is disposed. The light emitting source 220 is comprised of a plurality of cold cathode fluorescent lamps or a plurality of LED light bars. The optical reflective film 230 is disposed in the bottom of the containing space 212 and covers the bottom surface of the case 210. A plurality of light beams I₂ is emitted from the light emitting source 220. Some portions of light beams I₂ are reflected by the optical reflective film 230 and transmitted into the light guide plate 240. The structure and the functions of the optical reflective film 230 are similar to that of the optical reflective film 130, and are not described in detail herein.

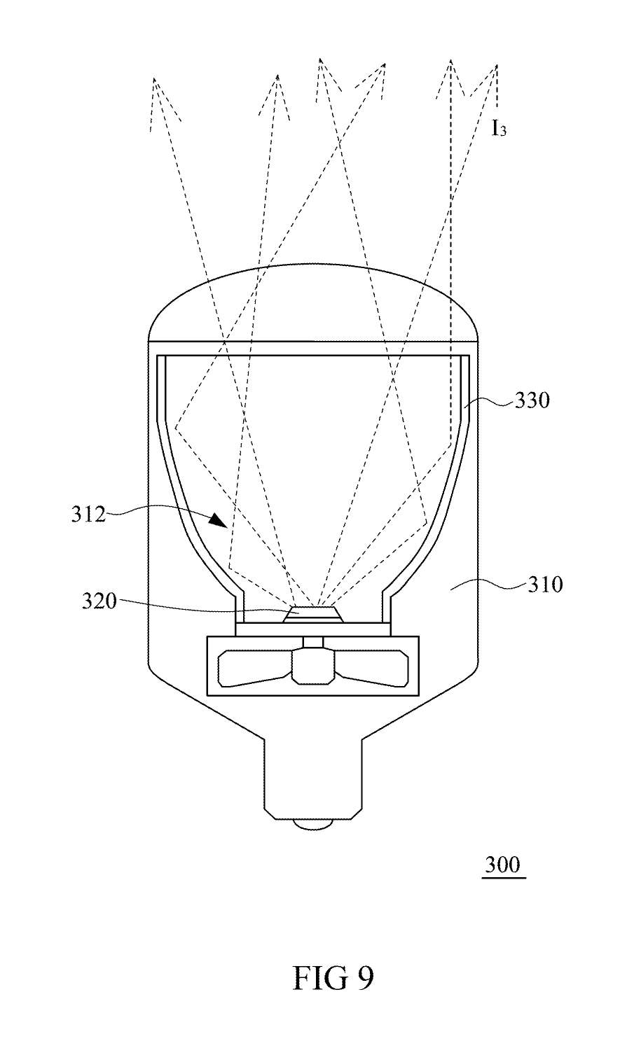

In FIG. 7 and FIG. 8, the embodiments of the light emitting device are the backlight assemblies. However, the light emitting device in the present invention can be a general illuminating device. Please refer to FIG. 9. FIG. 9 shows a third embodiment of the light emitting device in the present invention. The illuminating device 300 includes a case 310, a light emitting source 320, and an optical reflective film 330. The case 310 has a containing space 312 in which the light emitting source 320 is disposed. The light emitting source 320 is a LED lamp. The optical reflective film 330 is disposed in the containing space 312 and covers the inner surface of the case 310. Some portions of light beams I₃ emitted from the light emitting source 320 are reflected by the optical reflective film 330 and transmitted into the outside environment. The structure and the functions of the optical reflective film 330 are similar to those of the optical reflective film 130 and the optical reflective film 230, and are not described in detail herein.

Although the description above contains many specifics, these are merely provided to illustrate the invention and should not be construed as limitations of the invention's scope. Thus it will be apparent to those skilled, in the art that various modifications and variations can be made in the system and processes of the present invention without departing from the spirit or scope of the invention.

What is claimed is:

1. An optical reflective film, comprising:
a main body, the main body substantially comprising of polyolefin resin;
a plurality of organic particles, the organic particles disposed in the main body;
a plurality of inorganic particles, the inorganic particles disposed in the main body;
a plurality of voids, the voids disposed in the main body;
wherein the refractive index difference (N) of the optical reflective film is defined in the following equation:
$$N = \frac{\vert ( blr - alr ) \times blc \vert + \vert ( clr - alr ) \times clc \vert + \vert ( dlr - alr ) \times dlc \vert}{100}$$
and the value of refractive index difference (N) is ranged from 0.05 to 0.7; in the above equation, alr is the refractive index of polyolefin, alc is the weight percentage of the main body in the optical reflective film. blr is the refractive index of organic particles disposed in the main body, blc is the weight percentage of the organic particles, clr is the refractive index of the inorganic particles disposed in the main body; clc is the weight percentage of the organic particles; dlr is the refractive index of the voids disposed in the main body, and dlc is the void ratio of the optical reflective film.

2. The optical reflective film of claim 1, wherein the weight percentage of the organic particles in the optical reflective film is between 1% and 15%.

3. The optical reflective film of claim 1, wherein the diameter of the organic particle is ranged from 0.1 μm to 10 μm.

4. The optical reflective film of claim 1, wherein the refractive index of the organic particle (blr) is ranged from 1.30 to 1.70.

5. The optical reflective film of claim 1, wherein the weight percentage of the inorganic particle (clc) is between 1% and 24%.

6. The optical reflective film of claim 1, wherein the diameter of the inorganic particle is ranged from 0.01 μm to 1 μm.

7. The optical reflective film of claim 1, wherein the refractive index of the inorganic particle (clr) is ranged from 1.59 to 2.6.

8. The optical reflective film of claim 1, further comprising a plurality of fluorescent brightening agents which disposed in the main body, wherein the weight percentage of the fluorescent brightening agents in the optical reflective film is between 0.001% and 0.5%.

9. The optical reflective film of claim 1, further comprising a plurality of ultraviolet light absorbers which disposed in the main body, wherein the weight percentage of the ultraviolet light absorbers in the optical reflective film is between 0.02% and 1%.

10. The optical reflective film of claim 1, wherein the degree of crystallinity of the polyolefin resin of the main body is between 30% and 70%.

11. The optical reflective film of claim 1, wherein at least one protective layer is disposed on the surface of the main body.

12. A light emitting device, comprising:
a case, the case having a containing space;
a light emitting source, the light emitting source is disposed in the containing space, and the light emitting source emitting a plurality of beams of light and generating a plurality of optical paths;
an optical reflective film, disposed in the containing space and used for reflecting a portion of the emitted light, the optical reflective film comprising:
a main body, the main body substantially comprised of polyolefin resin;
a plurality of organic particles, the organic particles disposed in the main body;
a plurality of inorganic particles, the inorganic particles disposed in the main body;
a plurality of voids, the voids disposed in the main body; and
wherein the refractive index difference (N) of the optical reflective film is defined in the following equation:
$$N = \frac{\vert ( blr - alr ) \times blc \vert + \vert ( clr - alr ) \times clc \vert + \vert ( dlr - alr ) \times dlc \vert}{100}$$
and the value of N is ranged from 0.05 to 0.7; in the above equation, alr is the refractive index of polyolefin, alc is the weight percentage of the main body in the optical reflective film. blr is the refractive index of organic particles disposed in the main body, blc is the weight percentage of the organic particles, clr is the refractive index of the inorganic particles disposed in the main body; clc is the weight percentage of the organic particles; dlr is the refractive index of the voids disposed in the main body, and dlc is the void ratio of the optical reflective film.

13. The light emitting device of claim 12, wherein the weight percentage of the organic particles is between 1% and 15%.

14. The light emitting device of claim 12, wherein the diameter of each organic particle is ranged from 0.1 μm to 10 μm.

15. The light emitting device of claim 12, wherein the refractive index of the organic particles (blr) is ranged from 1.30 to 1.70.

16. The light emitting device of claim 12, wherein the weight percentage of the inorganic particles (clc) is between 1% and 24%.

17. The light emitting device of claim 12, wherein the diameter of the inorganic particle is ranged from 0.01 μm to 1 μm.

18. The light emitting device of claim 12, wherein the refractive index of the inorganic particle (clr) is ranged from 1.59 to 2.6.

19. The light emitting device of claim 12, wherein the optical reflective film further comprises a plurality of fluorescent brightening agents which are disposed in the main body, and the weight percentage of the fluorescent brightening agents in the optical reflective film is between 0.001% and 0.5%.

20. The light emitting device of claim 12, wherein the optical reflective film further comprises a plurality of ultraviolet light absorbers which are disposed in the main body, and the weight percentage of the ultraviolet light absorber in the optical reflective film is between 0.02% and 1%.

21. The light emitting device of claim 12, wherein the degree of crystallinity of the polyolefin resin of the main body is between 30% and 70%.
